(19) United States
(12) Patent Application Publication
(10) Pub. No.: US 2025/0037017 A1
(43) Pub. Date: Jan. 30, 2025

(54) WEIGHT COMPRESSION ACCURACY ENHANCEMENTS IN LARGE LANGUAGE MODELS

(71) Applicant: Intel Corporation, Santa Clara, CA (US)

(72) Inventors: Andrei Anufriev, Taufkirchen (DE); Alexander Kozlov, Dubai (AE); Yury Gorbachev, Novgorod (RU)

(21) Appl. No.: 18/599,833

(22) Filed: Mar. 8, 2024

(51) Int. Cl. G06N 20/00

(52) U.S. Cl. CPC G06N 20/00

(57) ABSTRACT

Systems, apparatuses and methods may provide for technology that accesses a pre-trained artificial intelligence (AI) model, quantizes a plurality of weights of the pre-trained AI model to generate a compressed AI model, and applies normalization correction to the compressed AI model to generate an output AI model.

### BACKGROUND

A large language model (LLM) is a type of language model notable for the ability to achieve general-purpose language understanding and generation. LLMs acquire these abilities by using large amounts of data to learn billions of parameters during training and consuming large computational resources during training and operation (e.g., inference). Weight data used by LLMs may originally be in a relatively high precision format such as, for example, the 32-bit floating point (FP32) format. Execution of LLMs on edge/client devices may be limited due to memory pressure during the loading of weights throughout the inference process. Quantizing the weight data used by LLMs to a lower-precision format such as, for example, 4-bit integer (INT4), can reduce the computational and memory demands of these modern architectures. Conventional quantization approaches, however, may encounter accuracy problems that negate the benefits of quantization.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of an optimization process flow according to an embodiment;

FIG. 2 is an illustration of an example of an affine transformation parameter estimation according to an embodiment;

FIG. 3 is a flowchart of an example of a method of generating an output artificial intelligence (AI) model according to an embodiment;

FIG. 4 is a flowchart of an example of a method of accessing a pre-trained AI model according to an embodiment;

FIG. 5 is a flowchart of an example of a method of applying normalization correction to a compressed AI model according to an embodiment;

FIG. 6 is a block diagram of an example of a performance-enhanced computing system according to an embodiment;

FIG. 7 is an illustration of an example of a semiconductor package apparatus according to an embodiment;

FIG. 8 is a block diagram of an example of a processor according to an embodiment; and

FIG. 9 is a block diagram of an example of a multi-processor based computing system according to an embodiment.

### DETAILED DESCRIPTION

The technology described herein provides a post-training model optimization solution that reduces the inference latency of large language models (LLMs) by compressing model weights and applying a post-compression procedure that substantially improves the final accuracy of the optimized model. First, the solution quantizes the weights of linear layers (e.g., fully connected and/or dense layers). In general, a linear transformation receives an input vector and maps the input vector to an output vector through a linear function. A linear layer of a neural network therefore receives an input tensor (e.g., input activation) and transforms the input tensor into an output tensor by performing a linear operation that involves weights and biases. Thus, the solution first quantizes the weights used in the linear operations that transform the input tensors into the output tensors of a neural network.

Next, the solution estimates the parameters of an affine transformation that is applied to the input of the last linear layer of the model, which helps to improve the accuracy of the optimized model. In general, the last linear layer of the model attempts to predict the next token (e.g., word) in a generated text sequence. The affine transformation that provides the input to the last linear layer is a type of geometric transformation that preserves collinearity (e.g., if a collection of points sits on a line before the transformation, the points all sit on a line afterwards) and the ratios of distances between points on a line.

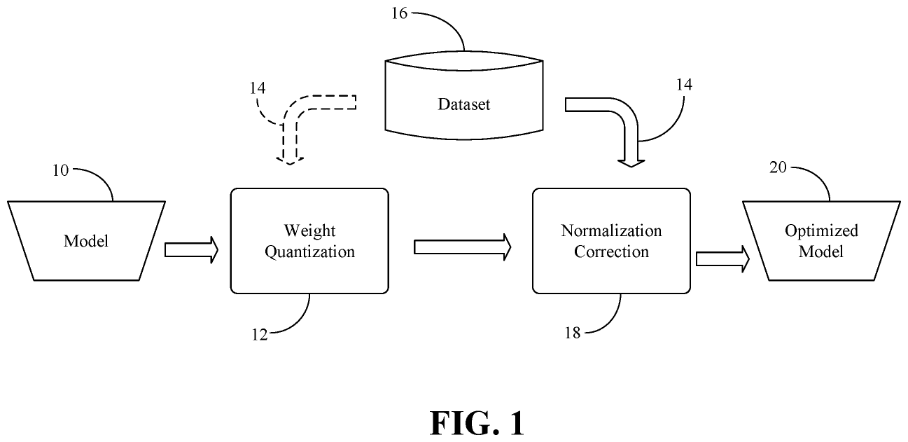

Turning now to FIG. 1, a process flow demonstrates that a pre-trained AI model 10 (e.g., source model of an LLM) undergoes a weight quantization operation 12 such as, for example, generative pre-trained transformer quantization (GPTQ). The weight quantization operation 12 can be a weight quantization or palletization to any arbitrary number of bits. In the illustrated example, the weight quantization operation 12 extracts a subset 14 of an input data set 16 and quantizes weights of the pre-trained AI model 10 in a layer-wise fashion into 4-bit, 3-bit or 2-bit integer precision (e.g., using zero-point and scale factors). The term “layer-wise” refers to the quantization of weight matrices of each layer independently for each row of the matrix. Moreover, each row can be “slitted” (e.g., partitioned) into equal groups so that each group has dedicated quantization parameters. The process starts from the first group of weights and estimates the quantization parameters, quantized weights and quantization error for the first group as argmin (WX-W′X), where W and W′ are the original weights matrix and quantized weights matrix, respectively, and X is the subset 14 (e.g., input data tensor). This error is considered when the second group of weights is being quantized. Although such an approach is based on a layer-wise quantization error (e.g., contributing to the improvement of inference latency), the overall error introduced by weight compression is not considered, which can lead to bias in the model.

The output of the weight quantization operation 12 (e.g., compressed AI model) undergoes a normalization correction operation 18, which restores the accuracy of the pre-trained AI model 10. More particularly, the normalization correction operation 18 performs a correction of the mean and variance of the activations within the compressed AI model at the input of the last prediction layer of the model, which forms the model output (e.g., usually linear or fully-connected layer). Parameters of per-channel affine transformation are estimated based on the data collected over the calibration data set 16. As will be discussed in greater detail, the affine transformation unifies (e.g., aligns) the inputs of the last layer between the pre-trained AI model 10 and an optimized model 20. The resulting optimized model 20 contributes to the improvement of the overall accuracy.

Thus, the input to the process flow is the pre-trained AI model 10 (e.g., LLM) and the output of the process flow is the optimized model 20, wherein the subset 14 (e.g., fixed subset D such as the first 128 samples with sequences larger than 128 characters) is extracted from the input data set 16. Each sample from D is fed to the pre-trained AI model 10 and averaged inputs are collected for the last linear layer of the pre-trained AI model 10: X_{fp32}∈R^{|D|×N}.

The weight quantization operation 12 (e.g., GPTQ) is then applied to the pre-trained AI model 10. During the weight quantization operation 12, each sample from D is fed to the compressed AI model and averaged inputs are collected for the last linear layer of the compressed AI model: X_{q}∈R^{|D|×N}.

The normalization correction operation 18 estimates parameters of the affine transformation as the error/loss function

$$arg {min}_{s , b} ‖ ( s * {X}_{q} + b ) - {X}_{fp 32} ‖ ,$$

where s, and b are vectors of per-channel scales (e.g., variance) and biases (e.g., mean, shift), respectively. The normalization correction operation 18 also fuses the affine transformation into the preceding normalization layer (LayerNorm) if a normalization layer exists or introduces an explicit affine transformation layer if a normalization layer does not exist. The illustrated process flow corrects only one layer in the entire pre-trained AI model 10 and is therefore relatively lightweight. Additionally, the process flow may be suitable for use on client or edge devices if, for example, the weight quantization operation 12 is data-free. Moreover, no additional copy of the pre-trained AI model 10 is created and the structure of the pre-trained AI model 10 remains unchanged throughout the optimization process. The improvement of accuracy is substantial relative to traditional GPTQ solutions for both 4-bit compression and 3-bit compression.

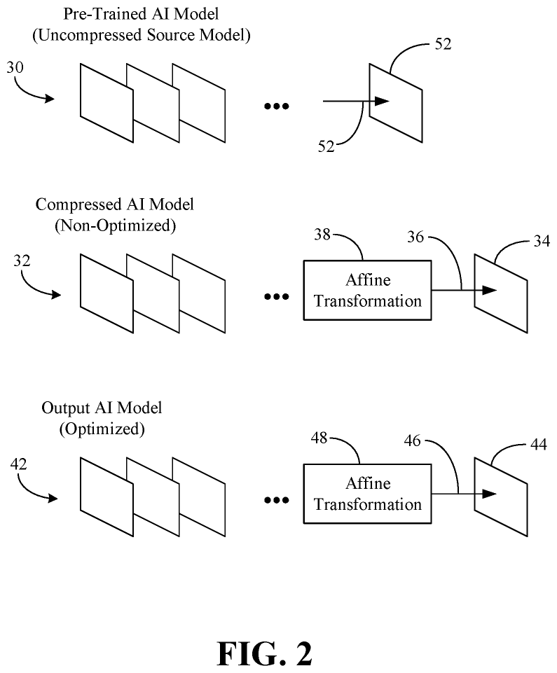

FIG. 2 demonstrates that a plurality of weights of a pre-trained (e.g., baseline) AI model 30 may be quantized to obtain/generate a compressed AI model 32. For each data sample of a subset of an input data set, averaged inputs 36 are collected for the last linear layer 34 of the compressed AI model 32. Additionally, parameters (e.g., per-channel scale vectors, per-channel bias vectors) of an affine transformation 38 are estimated based on the collected averaged inputs 36 and an error between the pre-trained AI model 30 and the compressed AI model 32. In one example, the error is the mean squared error (MSE) between inputs 50 to a last linear layer 52 of the pre-trained AI model 30 and the collected averaged inputs 36 to the last linear layer 34 of the compressed AI model 32. The estimated parameters are then incorporated into the affine transformation 38 of the compressed AI model 32 to obtain an optimized output AI model 42. In the illustrated example, the parameters of an affine transformation 48 of the output AI model 42 unifiy/align inputs 46 to a last linear layer 44 with the inputs 50 to the last linear layer 52 of the pre-trained AI model 30.

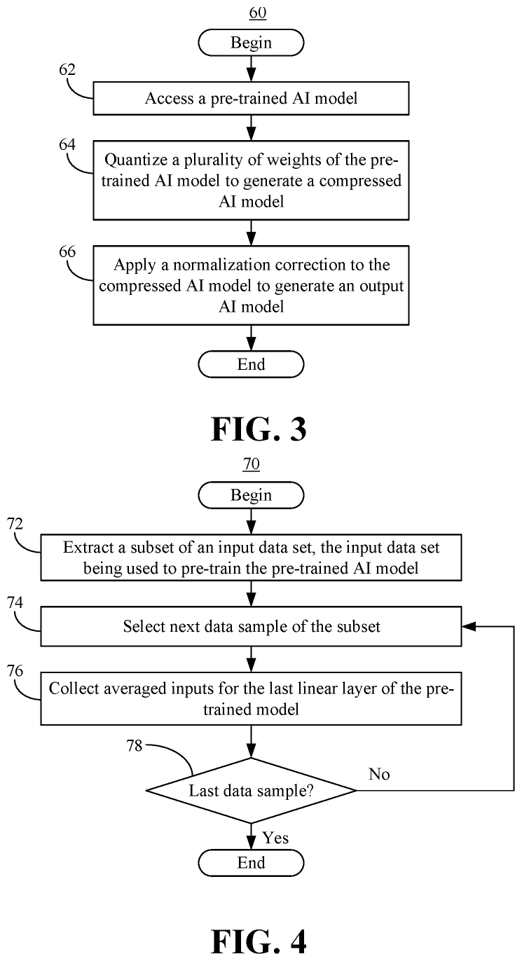

FIG. 3 shows a method 60 of generating an output AI model. The method 60 may be implemented in one or more modules as a set of logic instructions (e.g., executable program instructions) stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the method 60 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, micro-code, state-setting data, configuration data for integrated circuitry, state information that personalizes electronic circuitry and/or other structural components that are native to hardware (e.g., host processor, central processing unit/CPU, microcontroller, etc.).

Illustrated processing block 62 accesses a pre-trained AI model such as, for example, an LLM (e.g., source model). Block 64 quantizes a plurality of weights of the pre-trained AI model to generate/obtain a compressed AI model. In one example, block 64 uses GPTQ to quantize the weights of the pre-trained AI model. Additionally, block 66 applies a normalization correction to the compressed AI model to generate the output AI model. The method 60 therefore enhances performance at least to the extent that the normalization correction improves the accuracy of the output AI model.

FIG. 4 shows a method 70 of accessing a pre-trained model. The method 70 may generally be incorporated into processing block 62 (FIG. 3), already discussed. More particularly, the method 70 may be implemented in one or more modules as a set of logic instructions stored in a machine- or computer-readable storage medium such as RAM, ROM, PROM, firmware, flash memory, etc., in hardware, or any combination thereof.

Illustrated processing block 72 provides for extracting a subset of an input data set, wherein the input data set is used to pre-train the pre-trained AI model. Block 74 selects the next data sample of the subset and block 76 collects averaged inputs for the last linear layer of the pre-trained model. A determination may be made at block 78 as to whether the last data sample in the input data set has been reached. If not, the method 70 returns to block 74. Otherwise, the method 70 terminates.

The method 70 therefore further enhances performance at least to the extent that collecting averaged input for the last linear layer of the pre-trained AI model reduces latency and improves memory efficiency (e.g., copying the pre-trained AI model is bypassed/eliminated). Indeed, focusing on the inputs of the last linear layer enables the method 70 to be run on client or edge CPUs (central processing units) without a need for powerful deep learning training hardware. Moreover, the method 70 can be used in more complex scenarios that involve online model fine-tuning, optimization and deployment on the same device.

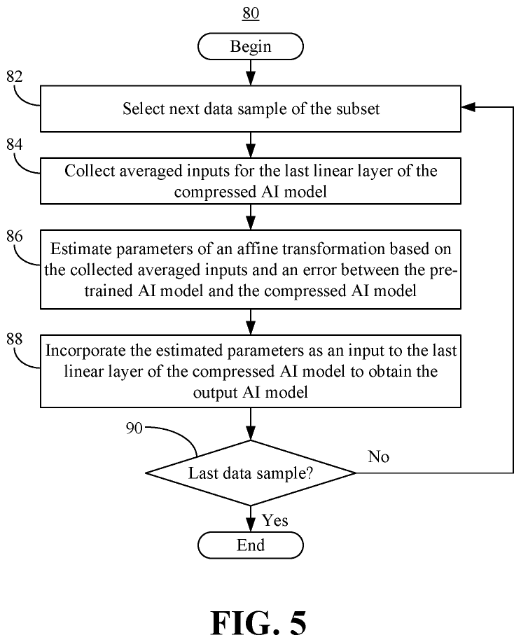

FIG. 5 shows a method 80 of applying normalization correction to a compressed AI model. The method 80 may generally be incorporated into processing block 66 (FIG. 3), already discussed. More particularly, the method 80 may be implemented in one or more modules as a set of logic instructions stored in a machine- or computer-readable storage medium such as RAM, ROM, PROM, firmware, flash memory, etc., in hardware, or any combination thereof.

Illustrated processing block 82 selects the next data sample of a subset of an input data set. In one example, the input data set is used to pre-train a pre-trained AI model. Block 84 collects averaged inputs for the last linear layer of the compressed AI model. Additionally, block 86 estimates parameters of an affine transformation based on the collected averaged inputs and an error (e.g., MSE) between the pre-trained AI model and the compressed AI model. The parameters may include per-channel scale (e.g., variance) vectors and/or per-channel bias (e.g., mean, shift) vectors. Block 88 incorporates the estimated parameters as an input to the last linear layer of the compressed AI model to obtain the output AI model. In one example, block 88 adds an affine layer to the compressed AI model, wherein the affine layer includes the estimated parameters. In another example, block 88 fuses the estimated parameters into a normalization layer. A determination may be made at block 90 as to whether the last data sample has been reached. If not, the method 80 returns to block 82. Otherwise, the method 80 terminates.

The method 80 therefore further enhances performance at least to the extent that incorporating estimated affine transformation parameters as an input to the last linear layer of the compressed model reduces latency and improves memory efficiency (e.g., copying the pre-trained model is bypassed/eliminated). Indeed, focusing on the inputs of the last linear layer enables the method 80 to be run on client or edge CPUs without a need for powerful deep learning training hardware. Moreover, the method 80 can be used in more complex scenarios that involve online model fine-tuning, optimization and deployment on the same device.

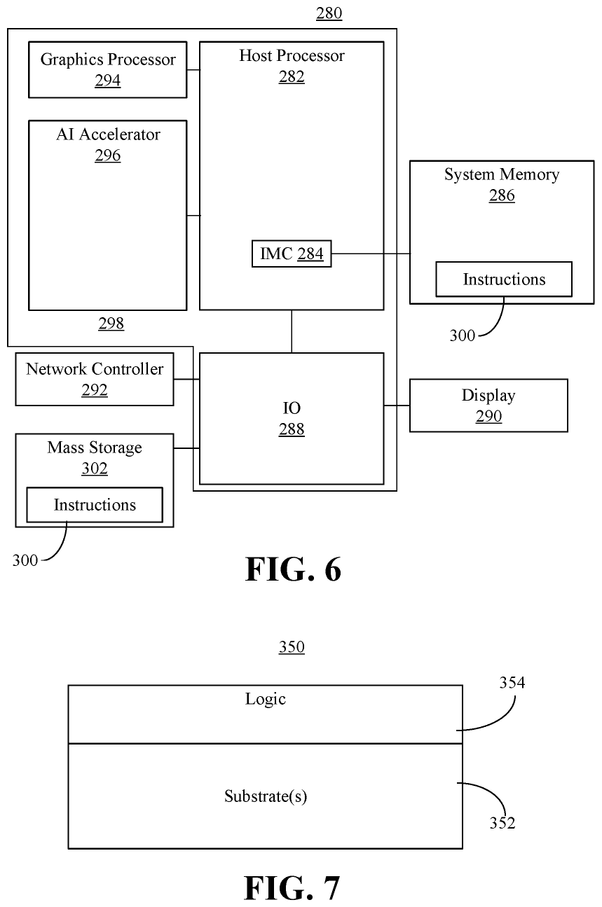

Turning now to FIG. 6, a performance-enhanced computing system 280 is shown. The system 280 may generally be part of an electronic device/platform having computing functionality (e.g., personal digital assistant/PDA, notebook computer, tablet computer, convertible tablet, edge node, server, cloud computing infrastructure), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, drone functionality, etc., or any combination thereof.

In the illustrated example, the system 280 includes a host processor 282 (e.g., central processing unit/CPU) having an integrated memory controller (IMC) 284 that is coupled to a system memory 286 (e.g., dual inline memory module/DIMM including a plurality of DRAMs). In an embodiment, an IO (input/output) module 288 is coupled to the host processor 282. The illustrated IO module 288 communicates with, for example, a display 290 (e.g., touch screen, liquid crystal display/LCD, light emitting diode/LED display), mass storage 302 (e.g., hard disk drive/HDD, optical disc, solid state drive/SSD) and a network controller 292 (e.g., wired and/or wireless). The host processor 282 may be combined with the IO module 288, a graphics processor 294, and an artificial intelligence (AI) accelerator 296 (e.g., specialized processor) into a system on chip (SoC) 298.

The host processor 282 and/or the AI accelerator 296 retrieves executable program instructions 300 from the system memory 286 and/or the mass storage 302 and executes the instructions 300 to perform one or more aspects of the method 60 (FIG. 3), the method 70 (FIG. 4) and/or the method 80 (FIG. 5), already discussed. Thus, execution of the instructions 300 by the host processor 282 and/or the AI accelerator 296 causes the host processor 282, the AI accelerator 296 and/or the computing system 280 to access a pre-trained AI model, quantize a plurality of weights of the pre-trained AI model to generate a compressed AI model, and apply normalization correction to the compressed AI model to generate an output AI model. The computing system 280 is therefore considered performance-enhanced at least to the extent that the normalization correction improves the accuracy of the output AI model.

FIG. 7 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. In an embodiment, the logic 354 implements one or more aspects of the method 60 (FIG. 3), the method 70 (FIG. 4) and/or the method 80 (FIG. 5), already discussed.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

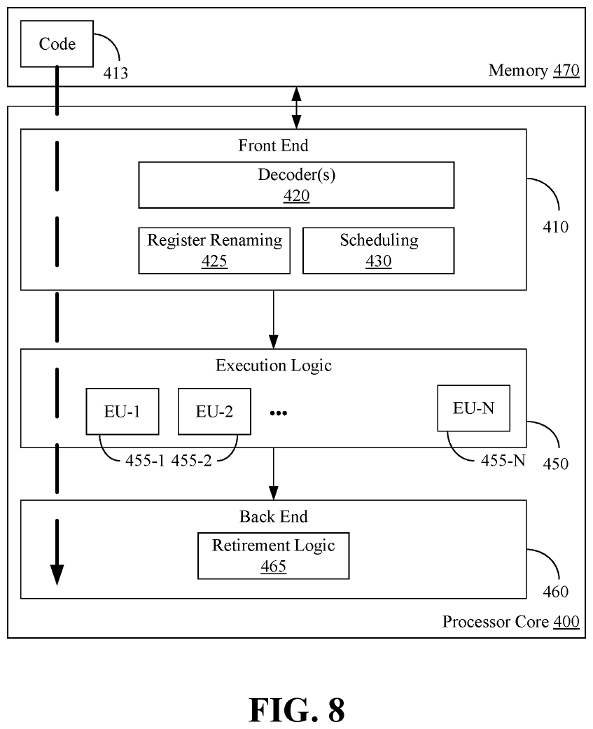

FIG. 8 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 8, a processing element may alternatively include more than one of the processor core 400 illustrated in FIG. 8. The processor core 400 may be a single-threaded core or, for at least one embodiment, the processor core 400 may be multithreaded in that it may include more than one hardware thread context (or “logical processor”) per core.

FIG. 8 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may implement the method 60 (FIG. 3), the method 70 (FIG. 4) and/or the method 80 (FIG. 5), already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 8, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

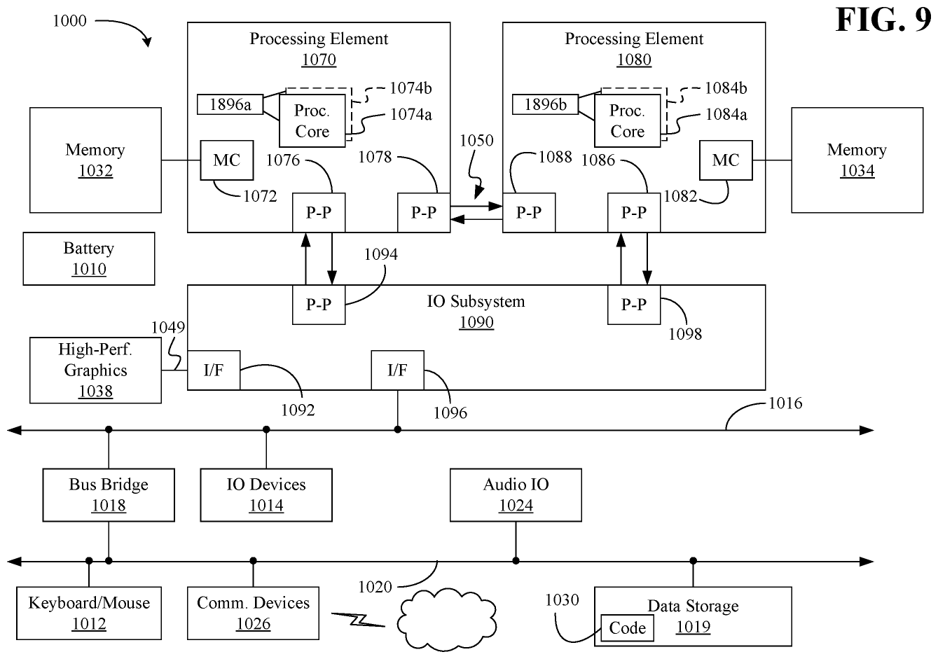

Referring now to FIG. 9, shown is a block diagram of a computing system 1000 embodiment in accordance with an embodiment. Shown in FIG. 9 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 9 may be implemented as a multi-drop bus rather than point-to-point interconnect.

As shown in FIG. 9, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 8.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor.

Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 9, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 9, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 9, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 60 (FIG. 3), the method 70 (FIG. 4) and/or the method 80 (FIG. 5), already discussed. Further, an audio I/O 1024 may be coupled to second bus 1020 and a battery 1010 may supply power to the computing system 1000.

Note that other embodiments are contemplated. For example, instead of the point-to-point architecture of FIG. 9, a system may implement a multi-drop bus or another such communication topology. Also, the elements of FIG. 9 may alternatively be partitioned using more or fewer integrated chips than shown in FIG. 9.

### ADDITIONAL NOTES AND EXAMPLES

Example 1 includes a computing system comprising a network controller, a processor coupled to the network controller, and a memory coupled to the processor, the memory including a plurality of executable program instructions, which when executed by the processor, cause the processor to access a pre-trained artificial intelligence (AI) model, quantize a plurality of weights of the pre-trained model to generate a compressed AI model, and apply normalization correction to the compressed AI model to generate an output AI model.
Example 2 includes the computing system of Example 1, wherein to access the pre-trained AI model, the executable program instructions, when executed, further cause the processor to extract a subset of an input data set, the input data set being used pre-train the pre-trained AI model, and for each data sample of the subset of the input data set, collect averaged inputs for a last linear layer of the pre-trained AI model.
Example 3 includes the computing system of any one of Examples 1 to 2, wherein to apply normalization correction to the compressed AI model, the executable program instructions, when executed, further cause the processor to for each data sample of a subset of an input data set, collect averaged inputs for a last linear layer of the compressed AI model, estimate parameters of an affine transformation based on the collected averaged inputs and an error between the pre-trained AI model and the compressed AI model, and incorporate the estimated parameters as an input to the last linear layer of the compressed AI model to obtain the output AI model.
Example 4 includes the computing system of Example 3, wherein the parameters are to include per-channel scale vectors.
Example 5 includes the computing system of Example 3, wherein the parameters are to include per-channel bias vectors.
Example 6 includes at least one computer readable storage medium comprising a plurality of executable program instructions, which when executed by a computing system, cause the computing system to access a pre-trained artificial intelligence (AI) model, quantize a plurality of weights of the pre-trained AI model to generate a compressed AI model, and apply normalization correction to the compressed AI model to generate an output AI model.
Example 7 includes the at least one computer readable storage medium of Example 6, wherein to access the pre-trained AI model, the executable program instructions, when executed, further cause the computing system to extract a subset of an input data set, the input data set being used to pre-train the pre-trained AI model, and for each data sample of the subset of the input data set collect averaged inputs for a last linear layer of the pre-trained AI model.
Example 8 includes the at least one computer readable storage medium of Example 6, wherein to apply normalization correction to the compressed AI model, the executable program instructions, when executed, further cause the computing system to for each data sample of a subset of an input data set, collect averaged inputs for a last linear layer of the compressed AI model, estimate parameters of an affine transformation based on the collected averaged inputs and an error between the pre-trained AI model and the compressed AI model, and incorporate the estimated parameters as an input to the last linear layer of the compressed AI model to obtain the output AI model.
Example 9 includes the at least one computer readable storage medium of Example 8, wherein the parameters are to include per-channel scale vectors.
Example 10 includes the at least one computer readable storage medium of Example 8, wherein the parameters are to include per-channel bias vectors.
Example 11 includes the at least one computer readable storage medium of any one of Examples 8 to 10, wherein to incorporate the estimated parameters as the input to the last linear layer of the compressed AI model, the plurality of executable program instructions, when executed, further cause the computing system to add an affine layer to the compressed AI model, and wherein the affine layer is to include the estimated parameters.
Example 12 includes the at least one computer readable storage medium of any one of Examples 8 to 10, wherein to incorporate the estimated parameters as the input to the last linear layer of the compressed AI model, the plurality of executable program instructions, when executed, further cause the computing system to fuse the estimated parameters into a normalization layer.
Example 13 includes a semiconductor apparatus comprising one or more substrates, and logic coupled to the one or more substrates, wherein the logic is implemented at least partly in one or more of configurable or fixed-functionality hardware, the logic to access a pre-trained artificial intelligence (AI) model, quantize a plurality of weights of the pre-trained AI model to generate a compressed AI model, and apply normalization correction to the compressed AI model to generate an output AI model.
Example 14 includes the semiconductor apparatus of Example 13, wherein to access the pre-trained AI model comprises, the logic is to extract a subset of an input data set, the input data set being used pre-train the pre-trained AI model, and for each data sample of the subset of the input data set, collect averaged inputs for a last linear layer of the pre-trained AI model.
Example 15 includes the semiconductor apparatus of Example 13, wherein to apply normalization correction to the compressed AI model, the logic is to for each data sample of a subset of an input data set, collect averaged inputs for a last linear layer of the compressed AI model, estimate parameters of an affine transformation based on the collected averaged inputs and an error between the pre-trained AI model and the compressed AI model, and incorporate the estimated parameters as an input to the last linear layer of the compressed AI model to obtain the output AI model.
Example 16 includes the semiconductor apparatus of Example 15, wherein the parameters are to include per-channel scale vectors.
Example 17 includes the semiconductor apparatus of Example 15, wherein the parameters are to include per-channel bias vectors.
Example 18 includes the semiconductor apparatus of any one of Examples 15 to 17, wherein to incorporate the estimated parameters as the input to the last linear layer of the compressed AI model, the logic is to add an affine layer to the compressed AI model, and wherein the affine layer is to include the estimated parameters.
Example 19 includes the semiconductor apparatus of any one of Examples 15 to 17, wherein to incorporate the estimated parameters as the input to the last linear layer of the compressed AI model, the logic is to fuse the estimated parameters into a normalization layer.
Example 20 includes the semiconductor apparatus of any one of Examples 13 to 17, wherein the logic coupled to the one or more substrates includes transistor channel regions that are positioned within the one or more substrates.
Example 21 includes a method of operating a performance-enhanced computing system, the method comprising accessing a pre-trained artificial intelligence (AI) model, quantizing a plurality of weights of the pre-trained AI model to generate a compressed AI model, and applying normalization correction to the compressed AI model to generate an output AI model.
Example 22 includes an apparatus comprising means for performing the method of Example 21.

The technology described herein therefore provides a model optimization technique that preserves the accuracy of the model while reducing the model size and memory bandwidth that is required to perform model inference. Thus, the technology described herein improves inference latency, reduces model weights and makes LLM inferencing on edge devices more affordable.

Embodiments may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a network controller;
a processor coupled to the network controller; and
a memory coupled to the processor, the memory including a plurality of executable program instructions, which when executed by the processor, cause the processor to:
access a pre-trained artificial intelligence (AI) model,
quantize a plurality of weights of the pre-trained AI model to generate a compressed AI model, and
apply normalization correction to the compressed AI model to generate an output AI model.

2. The computing system of claim 1, wherein to access the pre-trained AI model, the executable program instructions, when executed, further cause the processor to:
extract a subset of an input data set, the input data set being used pre-train the pre-trained AI model, and
for each data sample of the subset of the input data set:
collect averaged inputs for a last linear layer of the pre-trained AI model.

3. The computing system of claim 1, wherein to apply normalization correction to the compressed AI model, the executable program instructions, when executed, further cause the processor to:
for each data sample of a subset of an input data set:
collect averaged inputs for a last linear layer of the compressed AI model,
estimate parameters of an affine transformation based on the collected averaged inputs and an error between the pre-trained AI model and the compressed AI model, and
incorporate the estimated parameters as an input to the last linear layer of the compressed AI model to obtain the output AI model.

4. The computing system of claim 3, wherein the parameters are to include per-channel scale vectors.

5. The computing system of claim 3, wherein the parameters are to include per-channel bias vectors.

6. At least one computer readable storage medium comprising a plurality of executable program instructions, which when executed by a computing system, cause the computing system to:
access a pre-trained artificial intelligence (AI) model;
quantize a plurality of weights of the pre-trained AI model to generate a compressed AI model; and
apply normalization correction to the compressed AI model to generate an output AI model.

7. The at least one computer readable storage medium of claim 6, wherein to access the pre-trained AI model, the executable program instructions, when executed, further cause the computing system to:
extract a subset of an input data set, the input data set being used to pre-train the pre-trained AI model; and
for each data sample of the subset of the input data set:
collect averaged inputs for a last linear layer of the pre-trained AI model.

8. The at least one computer readable storage medium of claim 6, wherein to apply normalization correction to the compressed AI model, the executable program instructions, when executed, further cause the computing system to:
for each data sample of a subset of an input data set:
collect averaged inputs for a last linear layer of the compressed AI model;
estimate parameters of an affine transformation based on the collected averaged inputs and an error between the pre-trained AI model and the compressed AI model; and
incorporate the estimated parameters as an input to the last linear layer of the compressed AI model to obtain the output AI model.

9. The at least one computer readable storage medium of claim 8, wherein the parameters are to include per-channel scale vectors.

10. The at least one computer readable storage medium of claim 8, wherein the parameters are to include per-channel bias vectors.

11. The at least one computer readable storage medium of claim 8, wherein to incorporate the estimated parameters as the input to the last linear layer of the compressed AI model, the plurality of executable program instructions, when executed, further cause the computing system to add an affine layer to the compressed AI model, and wherein the affine layer is to include the estimated parameters.

12. The at least one computer readable storage medium of claim 8, wherein to incorporate the estimated parameters as the input to the last linear layer of the compressed AI model, the plurality of executable program instructions, when executed, further cause the computing system to fuse the estimated parameters into a normalization layer.

13. A semiconductor apparatus comprising:
one or more substrates; and
logic coupled to the one or more substrates, wherein the logic is implemented at least partly in one or more of configurable or fixed-functionality hardware, the logic to:
access a pre-trained artificial intelligence (AI) model;
quantize a plurality of weights of the pre-trained AI model to generate a compressed AI model; and
apply normalization correction to the compressed AI model to generate an output AI model.

14. The semiconductor apparatus of claim 13, wherein to access the pre-trained AI model comprises, the logic is to:
extract a subset of an input data set, the input data set being used pre-train the pre-trained AI model; and
for each data sample of the subset of the input data set:
collect averaged inputs for a last linear layer of the pre-trained AI model.

15. The semiconductor apparatus of claim 13, wherein to apply normalization correction to the compressed AI model, the logic is to:
for each data sample of a subset of an input data set:
collect averaged inputs for a last linear layer of the compressed AI model;
estimate parameters of an affine transformation based on the collected averaged inputs and an error between the pre-trained AI model and the compressed AI model; and
incorporate the estimated parameters as an input to the last linear layer of the compressed AI model to obtain the output AI model.

16. The semiconductor apparatus of claim 15, wherein the parameters are to include per-channel scale vectors.

17. The semiconductor apparatus of claim 15, wherein the parameters are to include per-channel bias vectors.

18. The semiconductor apparatus of claim 15, wherein to incorporate the estimated parameters as the input to the last linear layer of the compressed AI model, the logic is to add an affine layer to the compressed AI model, and wherein the affine layer is to include the estimated parameters.

19. The semiconductor apparatus of claim 15, wherein to incorporate the estimated parameters as the input to the last linear layer of the compressed AI model, the logic is to fuse the estimated parameters into a normalization layer.

20. The semiconductor apparatus of claim 13, wherein the logic coupled to the one or more substrates includes transistor channel regions that are positioned within the one or more substrates.
